(19) United States
(12) Patent Application Publication
(10) Pub. No.: US 2006/0095245 A1
(43) Pub. Date: May 4, 2006

(54) User interface mapping

(76) Inventors: Alvin J. Von Ruff, Gibson City, IL (US); Albert J. Lee, Urbana, IL (US)

Correspondence Address: MOTOROLA INC, 600 NORTH US HIGHWAY 45, ROOM AS437, LIBERTYVILLE, IL, 60048-5343, US

(21) Appl. No.: 10/978,761

(22) Filed: Oct. 30, 2004

(51) Int. Cl. G06F 13/10

(52) U.S. Cl. 703/21

(57) ABSTRACT

A device simulator (101) for simulating the user interface of a device is disclosed. The simulator comprises a graphical representation 102 of a device having a user interface (104, 106) having a plurality of input keys presented on a display. The simulator-further includes a key event mask (202) having a plurality of key masks, each key mask having a RGB color value and a shape substantially matching the shape of a corresponding input key of the plurality of input keys. The RGB color value includes a key event number encoded therein and readable by the controller of the simulator in response to a pointer or mouse event.

### FIELD OF THE DISCLOSURE

The present disclosure relates generally to portable electronic device, and more particularly to user interface simulation.

### BACKGROUND OF THE DISCLOSURE

It is known generally to create graphical representations of the user interface of a device for research and development purposes. It is also known to map events to predefined rectangular areas on a simulation screen.

The simulation of electronic devices is such as wireless communication devices for example is known. Graphical representations of the user interfaces of these devices such as the keypad and display are generated on a simulation display. The event of a button being depressed on a keypad is simulated by creating rectangular areas corresponding to location on the simulation display that map to original graphical representation of the buttons of the electronic device. A key event is assigned by software algorithm to the rectangular area and activated when a mouse event occurs with in the rectangular area on the display. Each rectangular area encompasses a corresponding button.

Keypad designs which are typically used on electronic devices are rectangular in nature as most follow the Bell Keypad design and this allows for a rectangular mask area to be used to determent when a mouse or pointer resides over the graphical representation a button. However, keypad designs that incorporated irregular shaped buttons for keypads that do not match a general rectangular area will not work with a rectangular mask. The rectangular mask area does not map appropriately to the graphical representation and may overlap other buttons depending on the shape of the button, the shape of adjoining buttons and the distance between the buttons.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary graphical representation on a simulation display.

FIG. 2 is an exemplary key event mask on illustrated on a simulation display.

FIG. 3 is an exemplary illustration of the key mask.

FIG. 4 is an exemplary flow diagram of the user interface simulation.

### DETAILED DESCRIPTION OF THE DRAWINGS

A method and apparatus for mapping a user interface image for simulation an electronic device is disclosed. The apparatus comprises a graphical representation of a user interface having a plurality of input keys presented on a display. The graphical representation is a simulation of the user interface of interest. A key event mask having a plurality of individual key masks, each key mask having a RGB color value and a shape substantially matching the shape of a corresponding input key of the plurality of input keys. The graphical representation of the user interface is presented on a display such as a CRT display coupled to a computer such as a PC.

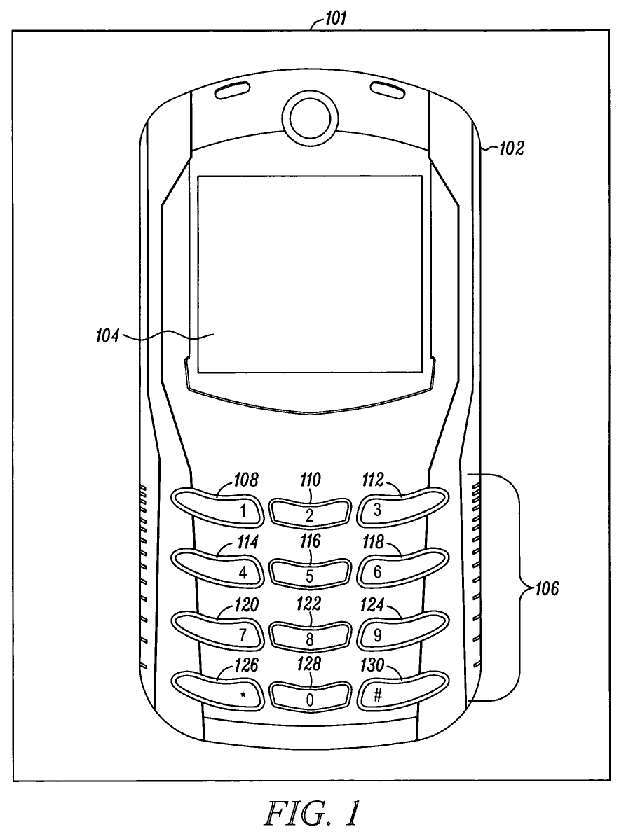

In developing a simulator for an electronic device for the purposes of software development, it is a requirement that a graphical representation of the user interface of the device itself (including both keypad and display) be created so that the user may input data for the simulation. In FIG. 1, an exemplary simulation display 100 is illustrated presenting a graphical representation 102 of a device having user interface 102. The graphical representation 102 is generated from the original art work of the device that is being simulated. In this exemplary embodiment, the device being simulated is a radiotelephone handset 102.

The radiotelephone 102 described herein is a representation of the type of wireless communication device that may benefit from the present invention. However, it is to be understood that the present invention may be applied to any type of hand-held or portable electronic device including, but not limited to, the following devices: radiotelephones, cordless phones, paging devices, personal digital assistants, portable computers, pen-based or keyboard-based handheld devices, remote control units, portable media players such as an audio player (such as an MP3 player) and the like. Accordingly, any reference herein to the radiotelephone 100 should also be considered to apply equally to other hand-held or portable electronic devices.

The exemplary simulation display 100 illustrated in FIG. 1, is a computer monitor coupled to a computer (not shown) which generates the images on the simulation display 100. The computer and the display make up the simulator 101 in this exemplary embodiment. The simulator includes a controller and memory for storing algorithms and data. The display may be carried on the computer or coupled thereto by wires. However it is to be understood that that the present invention may be applied to any type of display including, but not limited to, the following devices: a CRT display, an LCD, plasma, LED display, or the like.

FIG. 1 illustrates an exemplary graphical representation of the user interface 102 on the simulator 101. The user interface 102 in this exemplary embodiment is comprised of a display 104 and a keypad 106. The keypad 106 includes a plurality of features. In this exemplary embodiment the features are buttons or keys (input keys) comprising: a first key 108, a second key 110, a third key 112, a fourth key 114, a fifth key 116, a sixth key 118, a seventh key 120, an eighth key 122, a ninth key 124, a tenth key 126, an eleventh key 128 and a twelfth key 130. Each key has an irregular shape and in this embodiment no one key has the same shape.

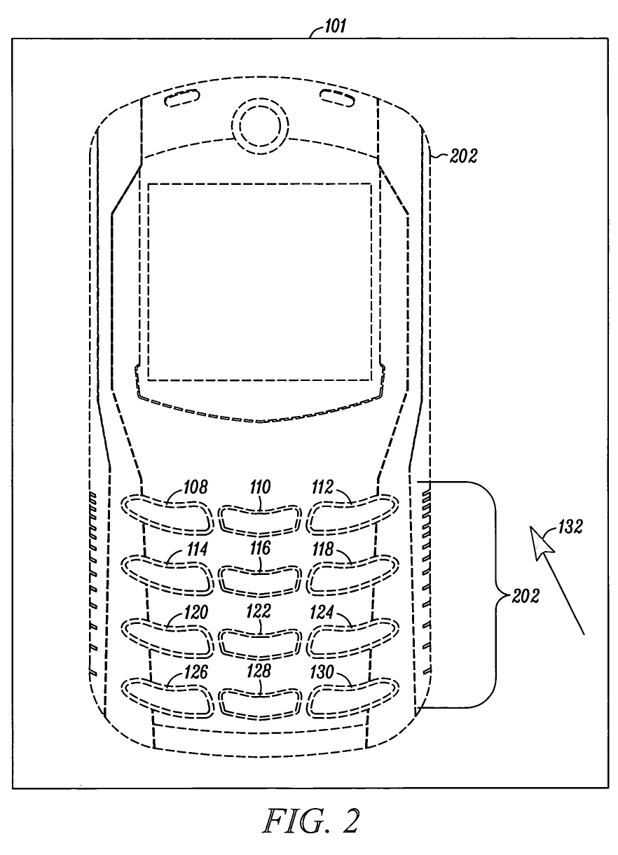

FIG. 2 illustrates the simulation display 100 showing an exemplary key event mask 202. The key event mask 202 is not displayed on the simulation display 100 and is not visible or transparent to the user. The key event mask 202 is shown in dotted line format for illustrative purposes to indicate the relative location on the simulation display 100 of the key event mask 202. The key event mask 202 is a data set that is generated from the original artwork of the device and retains location or position information and the color of each portion of the key event mask 202. The device or housing is one color and each user interface feature has it's own unique color. The key event mask 202 includes a plurality of key masks, wherein each key mask is associated with an input key of the plurality of input keys as generated from the original artwork. Each key mask is also associated with a RGB color value that is different form the color of the original artwork. The key mask shapes match in shape to the associated input key as they were both generated from the original art. Both the graphical representation and the key event mask may be generated automatically from the original artwork or by hand, tracking the original artwork for example.

The key event mask 202 in this exemplary embodiment comprises: a first key mask 208, a second key mask 210, a third key mask 212, a fourth key mask 214, a fifth key mask 216, a sixth key mask 218, a seventh key mask 220, an eighth key mask 222, a ninth key mask 224, a tenth key mask 226, an eleventh key mask 228 and a twelfth key mask 230. Each key masks respectfully corresponds to a feature of the in out device such as the first key 108, the second key 110, the third key 112, the fourth key 114, the fifth key 116, the sixth key 118, the seventh key 120, the eighth key 122, the ninth key 124, the tenth key 126, the eleventh key 128 and the twelfth key 130.

Since the input keys 108, 110, 112, 114, 116, 118, 120, 122, 124, 126, 128 of the graphical representation 102 and the key event mask 202 are generated from the same original art, each key mask aligns with an input key of the graphical representation 102. The key event mask 202 in this exemplary embodiment virtually overlays the graphical representation of the original art, however associated with different colors for each key of the keypad 116. For example, the first key mask 208 is assigned the same location relative to the simulation display 100 as the first key 108 such that when a pointer 132 presented on the display 100 is placed over the first key 108, the pointer 132 location is also within the location defined by the first key mask 208.

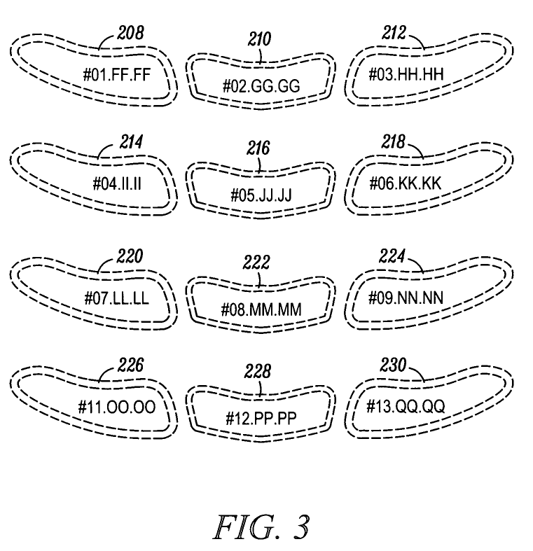

FIG. 3 illustrates the key event mask 202 and the RGB color values associated with each key mask of the key event mask 202 illustrated graphically for illustrative purposes. Each key mask is “painted” with a unique RGB color value. The RGB color value that is associated with a key contains at least one piece of information about the key of the graphical representation 102 associated with that key mask. For example, in one exemplary embodiment, a key event number is encoded or stored in the RGB color value for a corresponding key on the graphical representation 102. The irregular area described by for example, the first key mask 208 may be assigned the value #01.FF.FF, while the irregular area described by the second key mask 210 may be assigned with the value #02.FF.FF. The remainder of the graphical representation 102 that is not a key is left unmodified, having the same color as the graphical representation 102.

The method of simulating user interface features comprises generating on the simulation display 100 a graphical representation 102 of the user interface having a plurality of features. Each feature is irregularly shaped and individually unique such that no two features have the same shape in this exemplary embodiment. An event mask corresponding to the user interface is created wherein the event mask includes a feature event mask for each feature of the plurality of features of the user interface. The feature event mask has a corresponding irregular shape that matches the shape and location of a corresponding feature of the user interface. Each feature event mask has a RGB color value associated therewith.

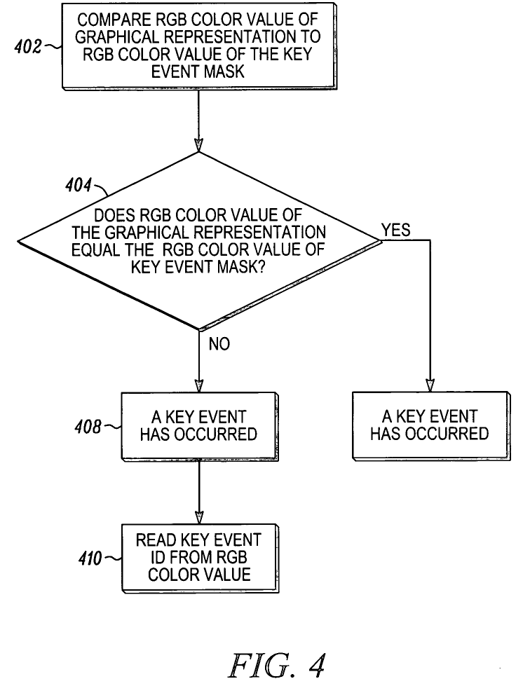

Moving to FIG. 4, an exemplary flow diagram shows the steps of determining whether a key event has occurred. In this exemplary embodiment, an algorithm compares a pointer location or position to a key event mask location of the key event mask 202 in order to determine the simulation event that is to occur. One exemplary pointer event is the event of the location or position of the pointer on the display 100 relative to the graphical representation 102 and the key event mask 202. Another exemplary pointer event is the event of clicking the mouse or pointer at a location on the display 100 relative to the graphical representation 102 and the key event mask 202.

The algorithm compares at block 402, the RGB color value of the graphical representation 102 at the pointer location to that of the key event mask 202 at the pointer location. When the user moves the pointer over the graphical representation 102, the pointer 132 will either be over a feature, or key in this exemplary embodiment, or a non key area which is the device housing area in this embodiment. At block 404, if the pointer 132 is over a housing area, a comparison of the RGB values of the graphical representation will be equal to or the same as that of the key event mask 202, and a key event will not occur, block 406. If the pointer 132 is over a key area, the RGB color values of the graphical representation 102 will not equal that of the RGB color value of the key mask, indicating a key event has occurred, block 408. The key event number or ID is then extracted or read from the RGB color value of the key mask, block 410. Once the key event number is read the next step is executing the event identified by the feature event number.

For example, if the pointer is positioned over the ‘1’ key of the graphical representation, the RGB color value of the key event mask for the ‘1’ key will not equal the RGB color value of the graphical representation 102 and the controller will read the key event number from the RGB color value of the key event mask at the position of the pointer. In this exemplary embodiment, #01.FF.FF is the key event number, identifying the key number ‘1’ of the input key and an event code. The controller reads the code for the event and executes an algorithm that corresponds to the event code. In this embodiment, the key number is stored as #01 and the event code is FF.FF.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A device simulator comprising:
a graphical representation of a device having a user interface having a plurality of input keys presented on a display; and
a key event mask having a plurality of key masks, each key mask having a RGB color value and a shape substantially matching the shape of a corresponding input key of the plurality of input keys.

2. The device simulator of claim 1,
wherein each key mask has a unique key event number encoded in the RGB color value.

3. The device simulator of claim 2, wherein the RGB color value is comprised of a input key number and an event associated with the input key.

4. The device simulator of claim 3, wherein the key event is one of a key highlight, a key press, or a key illumination.

5. The device simulator of claim 1,
a pointer presented on the display, the pointer appearing over the graphical representation.

6. the device simulator of claim 5,
wherein the key event mask is transparent to the user.

7. The device simulator of claim 1, comprising:
an x y coordinate associated with each key mask, representing the location of the key mask relative to the display.

8. The device simulator of claim 1, comprising:
an x y coordinate set associated with each key mask, representing the shape of the key mask relative to the display.

9. The device simulator of claim 1, a RGB color value comparison algorithm comparing the RGB color value of the graphical representation at a first display position and a RGB color value of the key event mask at the first display position.

10. The device simulator of claim 1, wherein the input keys are irregular shaped keys.

11. A method of simulating user interface features, the method comprising:
generating on a display a graphical representation of a user interface having a plurality of features;
creating an event mask of the user interface features, the event mask having a feature event mask for each feature of the plurality of features, the feature event mask matching the shape and location of a corresponding feature; and
wherein the each feature event mask has a RGB color value associated therewith.

12. The method of claim 11, further comprising comparing a RGB color value of the feature event mask to a RGB color value of the graphical representation,
wherein if the RGB color value of the feature event mask is equal to the RGB color value of the graphical representation, the pointer is not over a feature of the plurality of features, and
wherein is the RGB color value of the feature event mask is not equal to the RGB color value of the graphical representation, the pointer is over a feature of the plurality of features.

13. The method of claim 12, further comprising reading a feature event number embedded in the RGB color value of the feature event mask.

14. The method of claim 13, further comprising executing the event identified by the feature event number.

15. The method of claim 14, wherein the event is replacing a graphical representation feature image of the plurality of features.

16. The method of claim 15, wherein the features of the plurality of features are irregularly shaped.

17. A method of simulating a user interface, comprising the steps of:
comparing a RGB color value of a graphical representation at a pointer location to that of the key event mask 202 at the pointer location;
executing a key event when a pointer is over the grapohical representation and the RGB color value of the graphical representation does not equal the RGB color value of a key mask corresponding to a input key.

18. The method of claim 17, further comprising the steps of:
reading the key event number stored in the RGB color value of the key mask.

19. The method of claim 18, executing the event identified by the key event number.
